(19) United States
(12) Patent Application Publication
(10) Pub. No.: US 2010/0060973 A1
(43) Pub. Date: Mar. 11, 2010

(54) Imaging Device for Influencing Incident Light

(75) Inventors: Jean-Christophe Olaya, Dresden (DE); Sahm Hagen, Dresden (DE); Kranz Burkhard, Dohna (DE); Hans-Jurgen Roscher, Thum-Jansbach (DE); Volker Wittstock, Dresden (DE); Klaus Wold, Chemnitz (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A., Munsbach (LU)

(21) Appl. No.: 12/529,946

(22) PCT Filed: Feb. 28, 2008
(86) PCT No.: PCT/EP2008/001563

§ 371 Date: Sep. 4, 2009

(30) Foreign Application Priority Data
Mar. 5, 2007 (DE) 10 2007 010 906.9

(51) Int. Cl. G02B 26/00

(52) U.S. Cl. 359/291

(57) ABSTRACT

Disclosed is an imaging device for influencing incident light, comprising an optical element in the form of a mirror and an actuator for deforming the optical element. The optical element has a surface facing the incident light. The actuator laterally grips the optical surface of the optical element in order to deform the optical element.

The invention relates to a display device for influencing incident light, with an optical element and an actuator unit for deforming the optical element, where the optical element exhibits a surface which faces the incident light. Further, the invention also relates to a method for creating an optical image with the help of the optical element, and to a system for adjusting the position of an image plane of an image with the help of a display device as mentioned above.

The invention in particular relates to an adaptive optical system, which is mainly used for manipulating light. Such systems aim to change the phase in particular of spatially partly coherent or coherent light.

Adaptive optical systems are known from many prior art documents, where adaptive mirrors represent a certain sub-class of these systems. Such adaptive mirrors have previously been used mainly in astronomical equipment. A surface of the adaptive mirror is designed in a deformable way, such that phases of the reflected light can be influenced.

A number of different methods for deforming the reflecting surface and various designs of adaptive mirrors are known from the prior art. Typically, actuators are used to exert force on the mirror or on the reflecting surface which is to be deformed. Various types of actuators can be used for this, for example piezoelectric actuators, magnetostrictive actuators and electromagnetic actuators.

Document DE 197 25 353 A1, for example, describes a device for influencing a laser beam with the help of an adaptive mirror. The back of the mirror is fitted with a piezoelectric actuator body, where a pressure transmission means is disposed between the back of the mirror and the piezoelectric actuator body. In order to effect a deformation of the mirror, the pressure transmission means engages on almost the entire back of the mirror, where the piezoelectric actuator body does not affect the back of the mirror directly, but its force is transmitted through the pressure transmission means on to the mirror. Such systems have the drawback that the adjustment range of the mirror deflection is only minimal, because piezoelectric actuator bodies allow adjustments to be made in a small, limited range only.

Further, document US 2004/0150871 A1 describes a deformable mirror with a membrane, said mirror being deformed by piezo-actuators. Multiple bending actuators in the form of unimorphs are disposed on the back of the mirror in order to deform the same. In a unimorph, the piezoelectric layer is non-detachably connected with a non-piezoelectric, elastic layer, where the non-piezoelectric, elastic layer is conductive and serves as an electrode. Each actuator is coupled with the mirror membrane and can be discretely controlled in order to deform individual regions on the mirror. An electric voltage which is applied to the piezoelectric layer of an actuator induces a tension in the longitudinal direction, so that the piezoelectric unimorph is excited to press on to the respective region on the mirror and thus to deform it. However, the disadvantage of those systems is that such designs are only suitable for very small mirror diameters, because about 100 actuators are already necessary for example for a diameter of 8 mm in order to deform the mirror membrane accordingly. Such designs are thus not suitable for larger mirror diameters, because the number of actuators required increases substantially, so that the device becomes too complex and costly.

Further, document US 2006/013956 A1 describes a deformable mirror which exhibits a reflecting surface on a substrate. Moreover, a deformable layer which is capable of deforming the mirror as a result of its of expansion and contraction is disposed on the substrate. At least one actuator which also deforms the mirror is disposed on the back of the mirror. The actuator therein effects the basic deformation, and the deformable layer realises the fine-adjustment of the pre-deformed reflecting surface. It is particularly disadvantageous here that large adjustment ranges of the mirror or of the reflecting surfaces cannot be achieved. Moreover, it is difficult to achieve a targeted and uniform modification or adjustment of the curvature or deflection of the reflecting surface, because the force is exerted on a point of the back of the mirror only.

Another deformable mirror is known from document US 2006/0028703 A1. The mirror has a first, reflecting surface, a second surface and an integrated piezoelectric actuator, which comprises a carrier element and movable extension elements. The extension elements are based on the carrier element and are connected to the second surface, where electrodes are provided on the individual extension elements.

In order to effect a deformation of the mirror, the extension elements are moved in accordance with a control signal, so that the reflecting surface of the mirror is deformed. Again, large adjustment ranges of the mirror cannot be achieved here. The provision of such extension elements is rather expensive, and, moreover, the extension elements require a relatively long response time until the deformation is actually achieved.

Further, document US 2006/0245035 A1 describes a deformable mirror, where partition walls and the mirror form a multitude of sealed air chambers. A control element controls the air pressure in at least one air chamber. The air pressure can be controlled such that the shape of the mirror is modified. Such systems require additional elements, such as pressure control elements, valves, gas supply lines etc., so that their design and manufacture is very complicated and costly. Moreover, such gas-pressure-controlled reflecting optical systems exhibit a relatively great inertia. A similar device is shown in US 2006/0104596 A1.

DE 101 51 919 B4 describes an illumination objective comprising a mirror, the mirror comprises extensions being parallel to its optical axis. For deforming the mirror, forces can be introduced into the extensions via transmission elements by controlling an actuator. The mirror is fixed in the illumination objective using mounting elements. The optical surface is stretched or distorted with such a deformation of the mirror, thereby influencing its characteristic negatively.

Still further, segmented adaptive optical systems are known from prior art documents. However, these do not exhibit a satisfactory form stability of the reflecting surface.

It is therefore the object of the present invention to provide a display device for influencing incident light with the help of an optical element, said device eliminating the drawbacks of the prior art and being applicable in a wide range of applications as regards the influenced parameters of the optical element in a simple, inexpensive and efficient manner without adversely affecting the imaging quality of the optical element.

This object is solved according to this invention in that the actuator unit engages sideways on the optical surface of the optical element.

The display device according to this invention comprises for influencing incident light an optical element, preferably a mirror, and an actuator unit. The optical element exhibits a preferably reflecting optical surface which faces the incident light and which is used for imaging the incident light or for generating an image from the incident light. The actuator unit realises a deformation of the optical element by way of controlling it and thus exerts influence on the incident light. The actuator unit engages sideways on the optical surface of the optical element in order to deform the optical element. In the context of this invention, ‘engages sideways on the optical surface’ means an engagement to the surface of the optical element from the sides.

The sideways engagement to the optical surface only requires forces or moments which are relatively small compared with the forces required in already known adaptive optical elements in order to achieve the same deformation of the optical surface. The advantage is that the optical element can thereby be deformed in a large adjustment range (e.g. from a plane optical element or from a concavely curved optical element to a convexly curved optical element) without having to exert great forces compared with an engagement from the rear or back of the optical element. In addition, the travel distances of the actuator unit remain small. This means that the adjustment becomes possible in a range of several millimetres, and is not limited to a range of several micrometers, as known from prior art devices. Consequently, optical elements with a relatively large aperture can now also be deformed without suffering a reduction in optical quality and without having to use a multitude of actuators. In addition to large adjustment ranges, the display device according to this invention also allows a high adjustment speed and adjustment frequency to be achieved.

A sideways input of the forces from outside the optical surface for deforming the optical element also results in substantial advantages with view to the imaging quality. This way, neither instances of vignetting (shading) nor discontinuities can occur in the course of the bending line of the optical element as in known systems where actuators engage on the back of the optical element.

Because of the different adjustment of the deflection of the optical element, the focal length of the optical element changes in a very large range. This is why such a display device is an adaptive optical system which is particularly suited to track light, especially in holographic projection devices for tracking wave fronts according to the position of an observer when observing a preferably three-dimensional reconstructed scene. In addition to signal tracking and wave front tracking, the display device according to this invention can also serve for dynamically correcting wave front errors, for example in a holographic projection device, and for correcting system-specific aberrations.

A system for tracking an image signal in response to the output signal of a sensor is the subject matter of the claims 27 to 32.

According to a preferred embodiment of the present invention, the actuator unit can comprise at least one main actuator which can exert a force on the optical element in a direction which is about perpendicular to the optical axis of the optical element. The deflection or curvature of the optical element in the form of a bulging or warping deformation can be achieved by at least one main actuator on one side of the optical element, where the main actuator exerts a pushing compressive force on the side of the optical element, thus deforming the optical element if the optical element is held firm on the other side. However, it is preferred that at least one main actuator is provided on either side of the optical element, where the design is preferably centrally-symmetric. If identical forces are exerted on both sides on the optical element, a symmetric deflection will be generated. The deflection or bulging can thus be influenced by way of controlling the main actuator. What has been said above applies in particular to axially symmetric optical elements. A different number of actuators may be sensible for round optical elements or optical elements with yet another shape.

Alternatively, the actuator unit can comprise at least one main actuator which can apply a bending moment to the optical element, where the axis of the bending moment is about perpendicular to the optical axis of the optical element and about perpendicular to a radial direction of the optical axis. The deflection or curvature is in this case achieved by bending the optical element. It is also possible that one main actuator is provided which exerts a compressive force, and one main actuator which applies a bending moment on the optical element. The optical element can also be deformed this way. Again, it is preferred that one main actuator which applies a bending moment on the optical element is provided on either side of the optical element. It is further possible to apply a bending moment in addition to exerting a pushing force, as described above.

The advantage of bending is that the bending line suits the optically desired deformation better than a bulging curve.

Thanks to the sideways engagement of the main actuators on the optical element, little forces and moments suffice to realise the desired deflection or curvature of the optical element in a large adjustment range.

According to a further preferred embodiment of the present invention, at least one auxiliary actuator can be provided which can adjust a direction of curvature, in particular a deflection direction or a bulging direction, of the surface of the optical element. In order to set a required deflection direction, at least one auxiliary actuator is preferably provided. The auxiliary actuator can be disposed for example on a surface of the optical element which is facing away from the reflecting surface of the optical element. With bulging main actuators, the auxiliary actuator can set the deflection direction by way of pulling or pushing, depending on whether a convex or a concave bending line is required. With bulging main actuators, the auxiliary actuators also help to overcome the initial discontinuity in the bulging process and to realise also very small curvatures or deflections (i.e. large radii) of the optical element precisely.

Further, with a bending main actuator, the main actuator preferably comprises a lever which applies the bending moment on the optical element on the one hand and which is pivotally supported relative to its environment on the other, where the main actuator is assigned with at least one auxiliary actuator on which the lever of the main actuator is supported relative to its environment, where the auxiliary actuator performs a compensating movement to a not merely swivelling movement of the lever, which may be caused by the deflection of the optical element. The force of the main actuator is transmitted to the optical element through the lever, which is connected to the main actuator and the optical element. Because the optical element cannot or shall not additionally stretch while it is deflected, it is necessary that its supported edges are displaced according to the actual amount of deflection, which does not necessarily correspond with the swivelling motion of the lever. This can be done with the help of at least one auxiliary actuator which moves the main actuator such that in combination the desired lever movement is obtained and that the optical quality of the optical element is thus not impaired.

According to a preferred embodiment of the invention, it can further be provided that the optical surface of the optical element can be curved with a radius of curvature which is adjustable in an adjustment range of R=(−∞; −250 mm) to R=(+250 mm; +∞), depending on the desired influence on the light. With the help of such a large adjustment range, curvatures, in particular deflections, of the optical element can be achieved which are particularly preferably or necessary in order to obtain focal lengths of the optical element with which a tracking of the light according to a changed position of an observer, who observes for example a three-dimensional scene, can be realised, in particular in holographic projection devices.

Further, for the application in a holographic projection device for tracking the light or for defining an image plane of an image, a frequency in a range of between 2 Hz and 20 Hz, preferably 5 Hz, is preferably used for deforming the optical element in a large adjustment range, and a frequency of up to 150 Hz is preferably used for deforming the optical element in a fine adjustment range of 5% around the set-point value of the radius. The large adjustment range represents the total adjustment range in the context of this invention. The adjustment of the radius of the optical element or the deflection can be preferably achieved throughout the entire adjustment range with 5 Hz. In contrast, a fine adjustment of the radius or a minor change of the radius, in order to precisely adjust the set-point value of the radius, can be achieved with up to about 150 Hz. Such changes with up to about 150 Hz take place in a range of ±5% around the set-point value of the radius. Small adjustment travels are required for minor adjustments of the radius, which is why smaller forces and moments are applied on the system than with large-range adjustments for obtaining an initial bulging or bending; however, such changes must be much faster (up to about 150 Hz) in order to perform an optical error correction with three colours where a 50 Hz signal is given. This means that with small adjustment travels the differences in force become smaller. Nevertheless, the full amount of the force is applied and the force is dependent in a non-linear relation on the absolute position.

In order to be able to perform such high-precision controls and adjustments, a system for adjusting the position of an image plane of an image in the normal direction to the image Wane according to claim 27 is provided, said system comprising a controller or control unit and the display device described above, the display device is to be adjusted in response to an output signal of a sensor, in particular of a position detection sensor. This system can not only be used preferably in holographic projection devices but also in other fields. It may be preferred there if a large-range adjustment is performed at a frequency ranging between 2 Hz and 20 Hz, in particular at 5 Hz.

The auxiliary actuator can preferably be designed in the form of a piezo-actuator, because this type exhibits a very short response time in the range of a few microseconds and a great achievable force. Moreover, piezo-actuators can be dimensioned very well by coupling multiple piezo-stacks.

In the context of this invention it is possible to perform the large-range adjustment and the fine-range adjustment with the help of the main actuators.

The main actuator can therein preferably be an electro-dynamic drive, in particular a linear or rotating electromagnetic plunger coil drive. Such electro-dynamic drives, so-called voice coil drives, are characterised by a great repetition and positioning accuracy and great acceleration, so that the forces and bending moments can be applied on the optical element with high performance, and the positioning speed can be very high, according to the actual needs. The deflection of the optical element can be achieved and repeated at very high precision.

The optical element can be held in a frame which is formed by the actuator unit and which comprises holding elements which are disposed on opposite sides of the optical element and into which the optical element is clamped, where the holding elements are connected to at least one main actuator each, in particular to the lever, for applying the bending moment on the optical element. One holding element is thereby particularly preferably connected to the left-hand side, and one is connected to the right-hand side edge section of the optical element. In order to achieve a deflection of the optical element which is as symmetrical as possible, the optical element does preferably not have a circular shape, although this is of course also one possibility, but exhibits a polygonal shape. The holding elements can be moved towards the centre of the optical element during the deflection or bulging of the optical element. This way an undesired stretching or biasing of the optical surface is prevented, and the required optical quality is ensured without restrictions.

The object of the invention is further solved by a method for creating an optical image with the help of an optical element, where the optical element represents a part of a display device according to one of claims 1 to 16, and where the optical element is deformed with the help of an actuator unit which engages sideways on the optical surface.

In order to create an optical image or to influence light in an optical device, the display device with the optical element is controlled such that the optical element changes its focal length, whereby the focus of the light changes. This is achieved with a particularly high precision in a mechatronic actuator unit, where the control can be aided by a computer. This advantage can therein preferably be used in a holographic projection device for tracking the light according to a position of an observer who observes a two-dimensional and/or a three-dimensional scene. The light will be tracked in the display screen—observer region if the observer moves towards the display screen or away from it.

According to a preferred embodiment of the invention, wave front errors of a wave front which is imaged with the help of at least one deflection element, where the wave front hits the deflection element at an angle, are preferably corrected with the help of the display device with the optical element. If a wave front which originates in a light source is transmitted through an optical system, this wave front will be deformed. The deformed wave front has the effect that the imaging is disturbed and the image quality deteriorates. In order to eliminate the wave front errors, the display device is controlled through the actuator unit, i.e. the optical element is controlled and adjusted such that the deformation of the wave front is corrected in real-time by an adapted deflection or curvature of the surface of the optical element.

Further, it can be preferably provided that the chromatic aberration, in particular the longitudinal chromatic aberration is corrected with the help of the display device with the optical element. The chromatic aberration occurs if light is for example diffracted by a lens, where the short-wave, blue end of the spectrum is diffracted stronger than the long-wave, red end of the spectrum. Then, the different colours of the light do not converge in the focal point of the lens, because they have different focal points. Because different deflections of the optical element cause different focal lengths, it is possible to correct in particular the longitudinal chromatic aberration of an optical system with the help of the display device. The deflections of the optical element can thus be adjusted such that the individual focal points of the colours of the light always converge in a reference-wavelength focal point of the lens, whereby the chromatic aberration is minimised and thus the sharpness of the image is improved.

Further embodiments of the invention are defined by the other dependent claims. An embodiment of the present invention will be explained in detail below and illustrated in conjunction with the accompanying drawings, wherein:

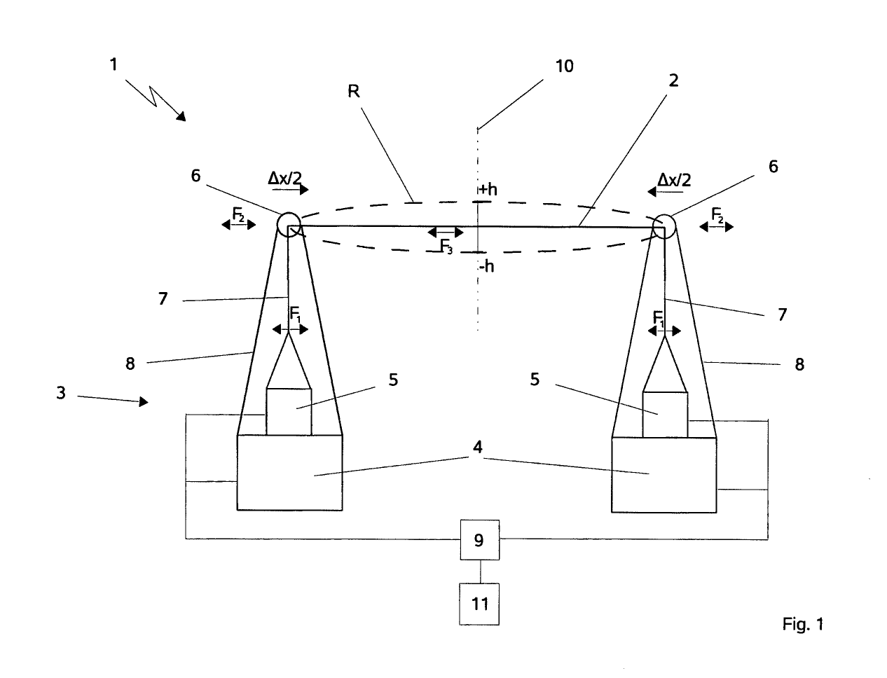

FIG. 1 is a side view showing schematically a first embodiment of a display device for influencing light;

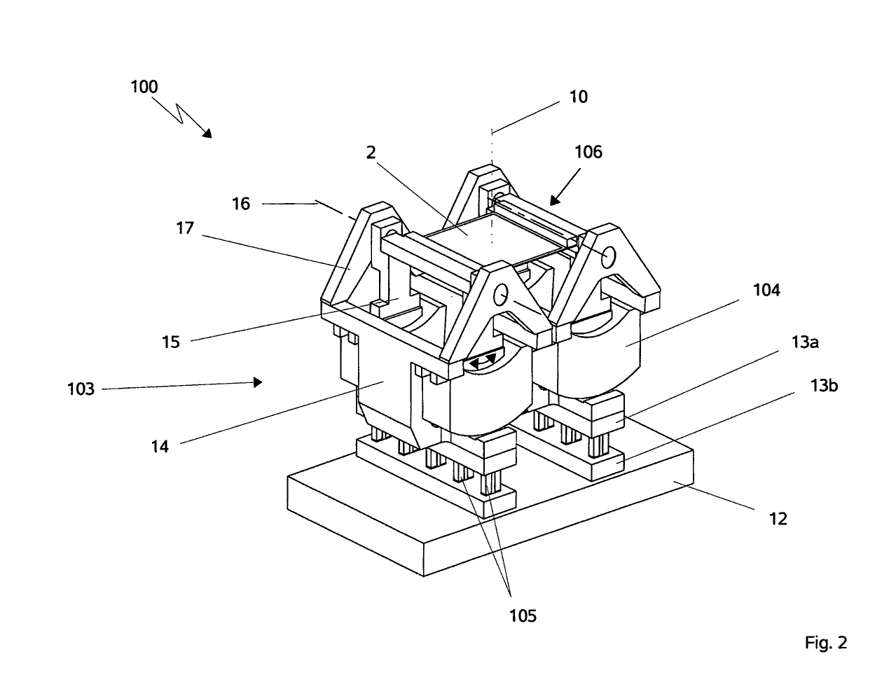

FIG. 2 is a perspective view showing another preferred embodiment of the display device;

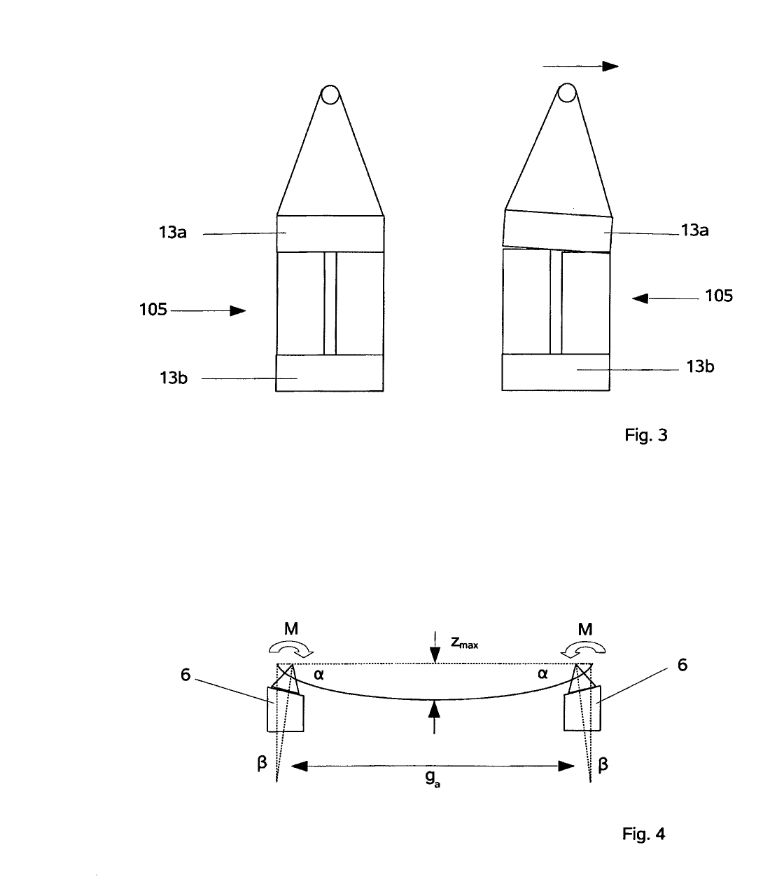

FIG. 3 is a schematic diagram illustrating the functional principle of an auxiliary actuator of the embodiment shown in FIG. 2;

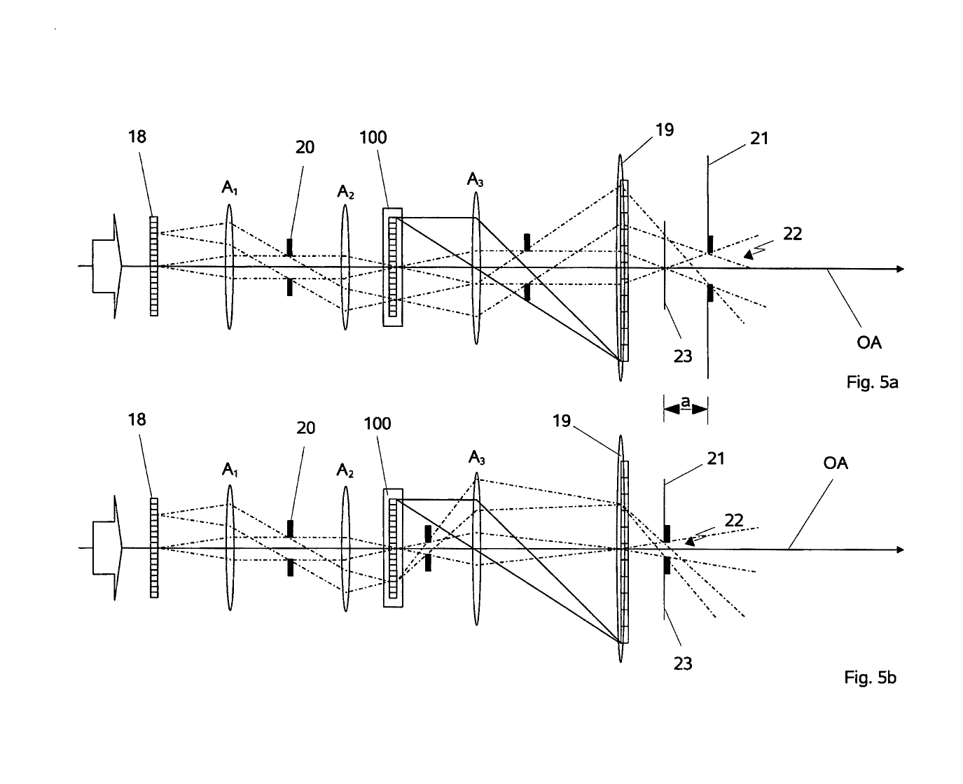

FIG. 4 is a schematic diagram illustrating the deflection of an optical element which is supported in the display device shown in FIG. 1;

FIG. 5a is a schematic diagram of a detail of a holographic projection device with the display device shown in FIG. 2, where the surface of the optical element is not bent; and

FIG. 5b is a schematic diagram of the holographic projection device shown in FIG. 5a, where the surface of the optical element is bent.

Now, the basic design and the functional principle of a display device 1 will be described.

FIG. 1 is a side view showing the general design of a display device 1, where the display device 1 is greatly simplified. The display device 1 comprises an optical element 2, here for example a mirror, an actuator unit 3 with at least one main actuator 4 and at least one auxiliary actuator 5. The illustrated embodiment of the display device 1 is of a symmetrical design and comprises two main actuators 4 and two auxiliary actuators 5, where one engages on the optical element 2 from the left, and one engages on the optical element 2 from the right.

The optical element 2 has a reflecting surface for reflecting or influencing light. For this, the optical element 2 is of a deformable design. The optical element 2 is preferably a mirror, in particular a cylindrical mirror, i.e. after the application of the forces on the optical element 2 so to effect its deformation, the optical element 2 has a reflective optical surface which is not of a spherical shape, but of a cylindrical shape. Because the optical element 2 shall be of a deformable design, it is important that it has a high optical surface quality while it exhibits a very good elastic deformability and fatigue strength. In order to achieve this, the basic material or carrier material can be any suitable elastic material, but steel (spring steel) or titanium are preferred as carrier materials. Now, different options for manufacturing such an optical element 2 will be described below.

A first possibility is that in a first step the carrier material, e.g. finely-ground spring steel, is machined to predefined parameters, such as size, thickness, shape and so on, with the help of known machining equipment. Then, in a second step, a material which serves as optical layer is deposited. For example, 100 μm nickel (NiP) can be deposited as optical layer on to the carrier material in an electroless plating process. The deposition is thereby preferably realised free of streaks, inclusions or other flaws which would affect the optical quality. This nickel-phosphor coating (NiP) exhibits properties which are characterised by the phosphor content and which, in particular as regards the hardness, can be precisely modified by way of tempering. Moreover, these NiP coatings exhibit a great resistance to wear and good anticorrosive properties, so that a long service life of the optical element 2 can be achieved. By taking advantage of the electroless plating method or (chemical deposition method), it can be made sure that the coating is deposited on the carrier material such that it follows its contours and that it always exhibits a uniform layer thickness. After application of the NiP coating, the material which thus serves as optical layer is treated in a milling process, in particular with the help of a rotating, preferably monolithic diamond tool, in a further step. The NiP coating is thus treated so to form the optical surface on the carrier material by way of milling, in particular in a fine machining process with a rotating diamond point (flycutting) This way the surface is made reflecting in a UHP (ultra-high precision) machining process.

Another possibility of manufacturing a suitable optical element 2 is to plane-grind and polish a carrier material, e.g. spring steel or spring bronze, and, subsequently, to coat the carrier material with aluminium in order to make a highly reflective optical surface. The thus deposited aluminium layer is covered by an additional thin protective coating which aims to protect the optical layer from ambient influences.

It is further possible to give the elastic carrier material, e.g. glass, silicon or carbon-fibre-reinforced plastic a plane surface such that an optically reflective coating is applied on to this surface.

A lamination of a reflectively coated plastic web on to an elastic carrier material would also be thinkable for manufacturing the optical element 2.

In order to deform the optical element 2, which is preferably of a polygonal shape to facilitate firm support, after its production, with the help of the display device 1 in order to influence incident light, the optical element 2 is disposed or supported in a frame formed by the actuator unit 3. The actuator unit 3 and thus the frame is of a two-piece design, where one holding element 6 on either side connects the frame with the respective edge section of the optical element 2, i.e. where the respective edge section is fixed to the respective holding element 6. This kind of support of the optical element 2 shall not create an elastic stretch of the optical element 2, but cause an elastic deflection. In order to realise this, the actuator unit 3 is designed like a movable bearing in order to achieve that the bearing or holding element 6 with the respective edge section can be moved towards the centre of the optical element 2 during the deformation or bending of the optical element 2.

As already mentioned above, the display device 1 comprises main actuators 4, which are mainly used to perform the deformation of the optical element 2. The main actuators 4 have the form of electro-dynamic drives, in particular of electromagnetic plunger coil drives. Further, the display device 1 comprises auxiliary actuators 5, which have the form of piezo-actuators and which are mainly used to perform the movement towards the centre of the optical element 2, as described above. Piezo-actuators are particularly suited as auxiliary actuators 5, because they exhibit a very short response time and can exert a great force. The auxiliary actuators 5 are connected with the main actuators 4, and the auxiliary actuators 5 are connected with the holding elements 6 through levers 7, and the main actuators 4 are connected with the holding elements 6 through the sides or levers 8. Further, the holding element 6 has a kind of joint which is directly connected with the lever 7.

In order to realise a deformation or deflection of the optical element 2, the auxiliary actuator 5 is controlled by a control unit 9 such that the auxiliary actuator 5 initiates a predefined deflection direction. This means that depending on how the light is to be influenced, the auxiliary actuator 5 is controlled or the auxiliary actuators 5 are controlled such that a concave or a convex deflection of the optical element 2 is realised by exerting a force F₁. The auxiliary actuators 5, which thus initiate or initialise the deflection in the most varied ways, also help to overcome the initial discontinuity in the bulging process, so that already very small deflections can be realised at great precision. In order to set a deflection direction likewise, the joints of the holding elements 6 or the optical element 2 can additionally be pre-stressed. Once the deflection direction is set by the auxiliary actuators 5, the control unit 9 controls the main actuators 4, which exert a force F₂ radial or orthogonal to an optical axis 10 of the optical element 2 on the optical element 2. The main actuators 4 thus create a translatory movement in the plane of the optical element 2. This exerts a required force F₂ on both sides, so that a translatory movement by Δx/2 is generated on either side, where Δx is the travel. It is assumed here that the entire system behaves symmetrically, so Δx is halved, because one half of the travel is realised on the one side, and one half of the travel is realised on the other side of the optical element 2. For fine adjustment, the holding elements 6 with the edge sections of the optical element 2 can additionally be moved by way of controlling the auxiliary actuators 5 accordingly. The forces to be exerted by the auxiliary actuators 5 result in a linear movement of the holding elements 6, as illustrated with the help of arrows above the holding elements 6. F₃ represents the force which is exerted on the optical element 2 during the deformation. The deflection of the optical element 2 is thus achieved by realising a free buckling or bending case, which is caused by the linear displacement of the edge sections of the optical element 2. The force is hence input to the optical element 2 from the sides and thus from outside the optical surface, so that neither vignetting nor discontinuities occur in the course of the bending line.

The deformation of the optical element 2 is elastic and can be effected in either deflection direction. When deforming the optical element 2 with the help of the display device 1, all forces are preferably set aided by a computer and transmitted mechatronically. A processor unit 11 or a controller temporally controls the intensity of the forces applied. The deformation can be monitored by measuring the travel (Δx) in the plane of the optical element 2 or the achieved deflection h. The set properties, such as forces, can be represented through Δx, h and R (radius of the optical element 2) on an output device.

The transmission of the forces on to the optical element 2 can be realised in a number of ways, for example using solid body joints of the holding elements 6, by way of a fix clamping of the optical element 2 in the holding elements 6, or by way of a free clamping of the optical element 2 in the holding elements 6 between two bearings.

The optical element 2 preferably exhibits an aperture of about 80 mm, while a larger or smaller aperture is of course also possible. The optical element 2, i.e. the optical surface of the optical element 2 has a surface with a radius R of almost ∞ prior to its deformation or prior to controlling the main actuators 4 and the auxiliary actuators 5. With the display device 1, the adjustment range for the deflection of the optical element 2 preferably lies in a range of R=(−∞; −250 mm) to R=(+250 mm; +∞), where the radius of the optical element 2 can be changed within this adjustment range depending on the influence on the light. This adjustment range corresponds with a deflection h of ±3.5 mm, given an aperture of about 80 mm. It is not possible to achieve such deflections with the help of prior art devices.

Further, by way of bringing about the required displacement for deforming the optical element 2 with the help of the main actuators 4 and/or the auxiliary actuators 5, high adjustment frequencies can be realised and the required forces can be applied. The optical element 2 can be affected or adjusted in the entire adjustment range or in a large-range adjustment of R=−250 mm to R=+250 mm at a frequency of 2 Hz to 20 Hz. A frequency of 5 Hz is particularly preferred. It is additionally possible to adjust the optical element 2 in small adjustment ranges, i.e. changes to the radius of ±5% around the set-point value (fine-range adjustment) at up to 150 Hz and more.

FIG. 2 is a perspective view which illustrates a further embodiment of the display device 100. The display device 100 is supported on an adjustment unit 12 so to ensure firm stand and to facilitate integration into a device. The auxiliary actuators 105 are supported on this adjustment unit 12 on both sides between two bearing plates 13a, 13b. As already mentioned with reference to FIG. 1, the auxiliary actuators 105 are piezo-torque-actuators, preferably stacks of individual piezo-elements. The individual auxiliary actuator 105 is a ceramic laminate with actuator units which are discretely controllable thanks to integrated electrode structures. The conversion of an angular tilt into a translatory movement is achieved directly in the solid body laminate and can be tapped at the end of a lever as a distance-translated excursion, see FIG. 3. The excursion and the stiffness can therein be varied according to certain specifications or parameters by designing the length of the levers, the height and the cross-section of the piezo-blocks. The functional principle of the auxiliary actuators 105 in the display device 100 shown in FIG. 2 will be described below.

The display device 100 shown in FIG. 2 is of a symmetrical design, like the one shown in FIG. 1, where two pairs of opposing main actuators 104 are provided. The main actuators 104 are pivotally supported in a frame 14, which is firmly connected to the upper bearing plate 13a. A lever 15, which is connected with the main actuator 104, is fixed on its other end in a articulated manner to the holding element 106. As shown in FIG. 2, two ends of levers 15 and one edge section of the optical element 2 together form a bearing shaft 16, where the respective main actuator 104 is pivotally fixed to the bearing shaft 16 through the lever 15. Within the frame 14, the main actuators 104, which are designed as electro-dynamic drives, can be swivelled in a certain range or under a certain angle. The levers 15 are connected with sides 17 of the frame 14 in order to support the bearing shaft 16 and to improve the overall stability.

In order to realise a deformation of the optical element 2, first The required set-point radius must be determined or specified depending on the desired influence on the light, where it must be known whether the deflection shall exhibit a concave or a convex bending line. Depending on which value is specified as the set-point value for the radius, the auxiliary actuators 105 are controlled by the control unit 9. The auxiliary actuators 105 thus receive a signal which commands them to pull or to push the optical element 2, depending on the required deflection, so to set the direction. This way the deflection direction or the bulging direction is set. It is then no longer required to control the auxiliary actuators 105. Then, the control unit 9 controls the main actuators 104 such that they perform a swivelling motion and thus create bending moments, which are applied on the optical element 2 through the levers 15. This means that when controlling the main actuators 104, the respective lever 15 moves left or right on a curved track, as illustrated by the arrow shown in FIG. 2, depending on the direction and strength of the current. This way, bending moments are applied on the optical element 2 on both sides of the optical element 2, whereby a symmetrical deformation is obtained. The axes of the bending moments are perpendicular to the optical axis 10 of the optical element 2 and perpendicular to a radial direction to the optical axis 10. A continuous control of the bending moments to be applied is necessary. While the optical element 2 is deflected, the deformation can be continuously measured, and a comparison of set-point and actual values can be conducted. The optical element 2 is scanned optically for this. The radius measured at this moment is transmitted as a signal to the control unit and analysed. In order to realise the required deformation of the optical element 2 with great precision, the control must be continuous. It can be particularly preferable if in a first step a defined radius of the optical element 2 to be deformed is generated in a large adjustment range for example at 20 Hz, and in a second step the set-point value of the radius is finely adjusted for example at 150 Hz with lower forces or bending moments. Adjustment in a small adjustment range here means a change of the radius in a range of ±5% around the set-point value. A change of the radius at 150 Hz becomes possible because the forces to be applied in the fine-range adjustment are very small in contrast to those required for initialising the deflection direction or for large-range adjustment. Attention is to be paid to the fact that the different forces and bending moments applied for overcoming the discontinuity when starting the bending or bulging process are coupled with one another and are subject to a continuous control. This way, the required set-point value of the radius can be adjusted with high precision.

While the bending moments are applied, it is necessary that the auxiliary actuators 105 move the positions of the holders of the edge sections of the optical element 2 in synchronism with the deflection. Because the holding elements 106 which hold the edge sections of the optical element 2 are virtually designed in the form of movable bearings, the tilting motion can be transformed into a linear displacement with the help of the levers 15 by way of controlling the auxiliary actuators 105 (see FIG. 3), so that the edge sections are moved towards the centre of the optical element 2 according to the amount of deflection. Moreover, the auxiliary actuators 105 can, if necessary, in addition to the bending moment of the main actuators 104 exert a compressive force which acts radial or orthogonal to the optical axis 10 of the optical element 2, in order to realise a stronger deflection.

In order to initialise a convex or concave deflection or bulging it is also possible that auxiliary actuators are disposed on the surface of the optical element 2 which faces away from its optical surface, i.e. on its back face. For this, the auxiliary actuators are formed as so-called piezo-patches, which are applied or glued to the back face, and which are controlled by a control unit so to realise the required deflection or bulging direction.

All forces and bending moments which are applied on the optical element 2 are set and monitored by a computer and transmitted mechatronically.

When deforming the optical element 2 with the help of the display device 1 or 100, different bending lines, for example a circle, an ellipse or a cosine can be set with the help of computer-aided, synchronised balancing of the various forces and bending moments applied. The required bending line can thus be realised depending on the force or bending moment to be applied. The bending line is a bending line which can of course be described mathematically and which is reproducible. This means that the bending line must be reproducible in dependence on the set value. This is preferably achieved in that the optical element 2 is supported by two symmetrically moved holding elements 6 or 106, which are designed as movable bearings, and which are displaced towards one another when the optical element 2 is deformed. Because the force is exerted from the sides of the reflecting optical surface of the optical element 2, the bending line will not show any discontinuities. The reproducibility of the bending line can be affected and improved by selecting different materials for the optical element 2. The bending line behaves differently, depending on the material used. In addition, it is also possible to make up learning curves with the help of the equation R=f(Δx), where the set radius is compared with the set-point value of the radius achieved after the deformation of the optical element 2, and where any possible deviations in influencing the light can be taken into account as well. With the help of such procedures it is made possible that a great form stability of the bending line is ensured. The form stability shall remain constant in different directions of the optical element 2. Because the forces are applied on the optical element 2 from the sides, discontinuities are prevented which would adversely affect the form stability.

The bending line can also be modified by influencing the cross-section of the optical element 2. This means that the cross-sections can be affected by varying the thickness of the optical element 2 before the optical element 2 is supported in the holding elements 6 or 106. For example, the edge sections of the optical element 2 can have a thickness that differs from the thickness of the central region or vice versa. The bending line can thus be modified by varying the thickness of the optical element 2. Moreover, this improves the reproducibility. The set properties of the bending line to be formed can also be represented, through Δx, h and R (see FIG. 1) on an output device.

In order to improve the controllability and to minimise intrinsic vibration, measures to reduce the weight and to minimise the required forces or bending moments can be provided, such as a specific design of the holding elements 6 or 106 or a specific design of the frame 14.

If such high frequencies are used for deforming, it will be necessary to provide sound-damping measures in the display device 1 or 100, so that the noise level can be lowered to an acceptable and reasonable degree. Now, there are various ways to achieve a sound-damping effect. A first possibility is to mount the display device 1 or 100 in a vacuum-tight housing. Because there is no medium inside the housing in which sound waves could propagate, a dampening effect can be achieved. A further possibility is to perform an active dampening with the help of additional actuators. The additional actuators are disposed for example on the surface of the optical element 2 which faces away from the optical surface of the optical element 2, where they perform an anti-vibration to the vibration generated by the display device 1 or 100. Piezo-based materials can be used too for such actuators. Further, it is also possible to achieve an active sound damping by damping the control itself. This can be achieved in particular by adjusting for example 90% of the set-point value of the required radius at a high speed, while the remaining 10% are adjusted at a noticeably lower speed. Further, it is also thinkable to achieve a passive sound damping by enclosing the display device 1 or 100 in its entirety, e.g. by supporting the display device 1 or 100 on vibration-damped foot elements.

FIG. 4 shows schematically the working principle of the application of moments on the optical element 2 so to achieve a deformation, where gₐ is the distance between the joints, M the bending moment and zₘₐₓ the maximum deflection in one deflection direction. The parameters for a required deformation of the optical element 2 can be specified and calculated with the help of the diagram shown in FIG. 4.

In order to achieve the required maximal adjustment range in one deflection direction of R≈250 mm, the parameters of the optical element 2 must be brought into agreement with the forces or bending moments, and a calculation analysis must be performed. For example, at a distance gₐ between the bearing joints of 100 mm, a thickness d of the optical element 2 of 0.7 mm; 0.6 mm, 0.5 mm and a width b of the optical element 2 of 80 mm, the following equations can be used to determine the maximum adjustment range in one deflection direction zₘₐₓ, the bending moment M_{L} to be applied, and the angle α between a plane surface of the optical element 2 and the surface bent to the maximum:

$${z}_{max} = \frac{M \cdot {g}_{a}^{2}}{8 \cdot E \cdot I} = \frac{3 \cdot M \cdot {g}_{a}^{2}}{2 \cdot E \cdot b \cdot {d}^{3}}$$

$$M = \frac{2 \cdot E \cdot b \cdot {d}^{3} \cdot {z}_{max}}{3 \cdot {g}_{a}^{2}}$$

$$α = \frac{M \cdot {g}_{a}}{2 \cdot E \cdot I} = \frac{6 \cdot M \cdot {g}_{a}}{E \cdot b \cdot {d}^{3}} \approx 11.5 °$$

The following table lists values which were determined for defining the design of the optical element 2 and the bending moments to be applied to realise the deflection:

| Distance | | | | | | | |
|---|---|---|---|---|---|---|---|
| gₐ | | | | | | | First |
| between | Elastic | | | Initial | | | natural |
| joints | modulus E | Width b | Thickness d | bulging f | Moment M | Angle α | frequency |
| (mm) | (N/mm²) | (mm) | (mm) | (mm) | (Nmm) | in ° | (Hz) |
| 100 | 210,000 | 80 | 0.7 | 5 | 1,920.8 | 11.5 | 167 |
| 100 | 210,000 | 80 | 0.6 | 5 | 1,209.6 | 11.5 | 143 |
| 100 | 210,000 | 80 | 0.5 | 5 | 700.0 | 11.5 | 119 |

The respective first natural frequency of the optical element 2 was determined using the finite element method (FEM). Because the first natural frequency of the optical element 2 must be higher than the control frequency (approx. 150 Hz), an optical element 2 with a thickness-d of 0.7 mm is preferred in order to prevent any possible resonance vibrations. The bending moment M which is to be applied on the optical element 2 in this example is about 1,920.8 Nmm.

It is of course possible to modify the thickness of the optical element, it shall be made sure, however, that the first natural frequency is always higher than 150 Hz.

FIG. 4 also shows the angle β. This angle β is derived with the help of the following equation:

$$β = \frac{0.15 mm}{100 mm} = 1.5 mrad \approx 0.085 °$$

The calculated angle β of ≈0.085° represents the value which must be achieved by the controlled auxiliary actuators 5 or 105 in order to realise a linear movement of the position of the holders of the edge sections of the optical element 2 at maximum deflection. Depending on the deflection of the optical element 2, the angle β can thus be changed in a range of between 0° and 0.085°.

Because the deflection of the optical element 2 is adjusted in a very large adjustment range with the help of the actuator unit 3 or 103 of the display device 1 or 100, the focal length of the optical element 2 is changed in a very large range along its optical axis 10. This fact thus allows the display device 1 or 100 to be used as an optical tracking system, for example as a part of a holographic projection device. An adaptive optical system with a very large dynamic range and a high adjustment speed is required for tracking a light wave front in accordance with an observer position in front of a display screen. Such a required adaptive optical system must exhibit the ability of achieving a large adjustment range of the radius, great form stability, and the ability to set convex and concave deflections and to create a reproducible bending line. All these requirements are fulfilled by the display device 1 or 100 according to this invention.

The image or image plane is tracked in the direction towards an optical axis of a holographic projection device according to a measured input parameter, such as for example a position of an observer in front of a display screen.

Now, the functional principle of the display device 100 for the use in a holographic projection device, which is used for holographically reconstructing of two-dimensional and/or three-dimensional scenes, will be described in detail below, referring to FIGS. 5a and 5b. It is of course also possible to employ the display device 1 or 100 for example in astronomical telescopes, in imaging light exposure systems for imaging an image of a mask (reticle) on to a photosensitive substrate (wafer), in laser-beam machining equipment, in fields such as medical engineering, automotive industry or other fields of application where such a display device 1 or 100 is of use.

Only those parts which are of major importance for the invention are shown in the detailed views of a holographic projection device shown in the FIGS. 5a and 5b. Such a holographic projection device is known for example from document DE 10 2005 023 743, where the functional principle will be described in brief below. The holographic projection device shown in FIGS. 5a and 5b comprises a light modulator device 18, which is preferably illuminated with coherent light, imaging elements A₁, A₂, A₃ and a display screen 19. The optical path is shown unfolded in both diagrams in order to simplify the drawing and to facilitate understanding. Referring to FIG. 5a, a hologram which is encoded on the light modulator device 18, or the light modulator device 18 itself is imaged by the imaging elements A₁, A₂, A₃, which are here represented by lenses, on to the display screen 19, where only two optical paths are shown to represent the wave front. The optical paths are indicated by broken lines. A spatial frequency filter 20, which is disposed in a plane of the spatial frequency spectrum, for example an aperture, is imaged at the same time through the imaging elements A₁, A₂, A₃ and the display screen 19 into an observer plane 21 and this way generates a virtual visibility region or a virtual observer window 22 there. As can be seen, the light modulator device 18 is imaged through the imaging elements A₁, A₂ into an image-side focal plane of the imaging element A₂ or in an object-side focal plane of the imaging element A₃. The image of the light modulator device 18 which is created there is an inverse image. The light modulator device 18 is then imaged through the imaging element A₃ on to the screen 19. The continuous beams illustrate how the light modulator device 18 is imaged on the screen 19. Because the image of the light modulator device 18 which is created in the object-side focal plane of the imaging element A₃ is an inverse image, the image of the light modulator device 18 on the display screen 19 is upright again.

In order to enable an observer to observe the reconstructed, preferably three-dimensional scene, he must look through the virtual observer window 22 with at least one eye, i.e. the observer window 22 must ideally concur with the pupil of the observer eye. However, in order to enable the observer to observe the reconstructed scene without any restrictions when he moves towards the display screen 19 or away from it along the optical axis OA, the virtual visibility region or the virtual observer window 22 must be tracked to the respective observer eye.

In order to achieve this, the display device 100 described above is disposed between at least one light modulator device 18 and the display screen 19, in order to be able to track the virtual observer window 22 along the optical axis OA of the holographic projection device. The display device 100 is therein preferably disposed in a plane in which an image of the light modulator device 18 is created, for example between the imaging elements A₂ and A₃, where these are shown in a very simplified manner in the FIGS. 5a and 5b. The disposition of the display device 100 in such a plane is very important because the image of the light modulator device 18 otherwise moves on the display screen 19 and a precise reconstruction of the scene as required becomes impossible. Because the display device 100 is disposed in such a plane, it does thus not affect the image of the light modulator device 18 on the display screen 19. FIG. 5a shows the two optical paths in the case in which the display device 100 is not controlled. The optical element 2 thus exhibits an almost plane surface.

FIG. 5b shows the holographic projection device of FIG. 5a, but where the optical element 2 of the display device 100 is curved so to track the observer window 22 along the optical axis OA. The image-side focal plane of the display device 100 here now concurs with the object-side focal plane of the imaging element A₃. Thereby, the image of the spatial frequency filter 20, which is created in this plane, is imaged to infinite space, so that the spatial frequency filter 20 is not imaged between the imaging element A₃ and the display screen 19. This way the observer window 22 which is formed by the image of the spatial frequency filter 20 is created in an image-side focal plane 23 of the display screen 19. The light modulator device 18 is at the same time imaged on to the display device 100, and then through the imaging element A₃ on to the screen 19, as already explained above. This imaging is thus not affected by the display device 100. As can be seen when comparing the two holographic projection devices shown in FIGS. 5a and 5b, the observer window 22 in FIG. 5b is displaced along the optical axis OA by a distance a towards the display screen 19.

Now, it will be described how the required deflection of the optical element 2 is achieved in order to be able to track the observer window 22, as shown in FIG. 5b. As already mentioned above, the optical element 2 to be deformed is preferably a cylindrical mirror. A spherical mirror as optical element 2 would be more appropriate, but this would not be realisable with the requirements specified above. However, in order to create the effect of a spherical optical element, two display devices 100, of which one is turned by 90° in relation to the other, are disposed one behind another on the optical axis OA of the holographic projection device, where each display device 100 comprises a cylindrical mirror. The effect of the display device 100 which is disposed first on the optical axis OA of the holographic projection device, seen in the direction of light propagation, and which comprises the first cylindrical mirror, is centred to the effect of the subsequent display device 100 which comprises the second cylindrical mirror. The two cylindrical mirrors only act in one plane each, where the two respective planes differ. The two display devices 100, which are disposed one after another, must now deform their cylindrical mirrors such that a change in the focus of the light is achieved as if a spherical mirror was deformed.

In order to track the virtual observer window 22 along the optical axis OA of the holographic projection device, the actuators 4 and 5 or the display devices 100 are controlled such that the respective optical element 2 is deformed such that the wave front is given a required convergence, or that the latter is added, so that the light is focussed to a desired position along the optical axis OA. This way the observer window 22 can be tracked towards the display screen 19 or away from it along the optical axis OA as the position of the observer changes.

The virtual observer window 22 will only be tracked using the display device 100 if the observer(s) move(s) towards the display screen 19 or away from it. If the observer(s) move(s) within the observer plane 21, another display device, e.g. a galvanometer mirror, will be necessary in order to deflect the wave front in the horizontal direction.

The display device 1 or 100 also aims to dynamically correct wave front errors and system-specific aberrations, in addition to signal tracking.

The two display devices 100 can also serve at the same time to correct wave front errors in the holographic projection device. Because the observer also moves within the observer plane 21, it will again be necessary to track the virtual observer window 22 to the observer when he moves, so to enable him to continue observing the reconstructed scene. This tracking is performed with the help of a deflection element, as already mentioned above, where, however, wave front errors or aberrations occur as side-effects. They strongly affect the tracking quality or the quality of the virtual observer window 22. In order to correct such wave front errors, the surface of the optical element 2, for example of only one display device 100, is deformed in a slightly different way, e.g. by a stronger curvature than necessary for tracking the virtual observer window 22. This means that it is possible to correct the wave front errors and to track the virtual observer window 22 at the same time, where the surface of the optical element 2 is deformed according to a correction of the wave front errors and, simultaneously, a special surface shape is added so to realise the tracking. This means that two surface shapes are geometrically added.

System-specific aberrations or geometrical aberrations, such as astigmatism, can be corrected in a particularly preferable way with the help of the two display devices 100. However, it is also possible to correct other geometrical aberrations, where the reduction of the general sum of aberrations is most sensible with an optical optimisation for example in a holographic projection device.

Because also lenses and lens systems (for example the imaging elements A₁, A₂, A₃) are provided besides mirrors (for example the optical element 2) in the holographic projection device for imaging the light, chromatic aberrations occur during the passage of the light through the lenses. This means that the chromatic aberration occurs because of the wavelength dependence of the refractive index of the lens. Light of different wavelengths is focussed in different points. Because the observer also wants to watch the reconstructed scene in colour, it is necessary to reconstruct a colour scene in real-time, e.g. using a time multiplex method. Colour reconstruction of the scene is thereby achieved by sequentially processing the three primary colours, RGB (red, green, blue). To perform this type of reconstruction, a preferably coloured light source, which exhibits sufficient coherence, and a switching unit are required in order to control the monochromatic primary colours, RBG, sequentially. This allows the colour reconstructions to be generated one after another at high speed. However, the chromatic aberration which occurs thereby, i.e. because blue light is diffracted more strongly than red light, so that the focal points of the monochromatic light beams do not concur, thus deteriorates the image quality.

In particular the longitudinal chromatic aberration can be corrected with the help of the display device 1 or 100, which is first of all provided for tracking the virtual observer window 22, by correspondingly deforming the optical element 2. The position of the virtual observer window 22 is thus not only defined geometrically, but also wavelength-specifically.

In order to enable an observer to observe the reconstructed colour scene without any restrictions, it is necessary that the switching operations between the individual monochromatic primary colours RGB are performed at high speed, while simultaneously correcting the chromatic aberration. If the reconstruction of the scene is provided for both eyes of the observer in one optical path, then a switching operation from the left to the right eye and vice versa is necessary, which must again be performed at high speed, so that the observer gets the impression to watch the reconstructed scene simultaneously with both eyes. In addition, the virtual observer window 22 must be tracked to the new observer position if the observer moves. Assuming that the observer moves at a speed of about 20 cm/s, the image signal can be tracked for one eye slowly during a deformation of the optical element 2 at about 25 Hz in the mentioned large-range adjustment. For two eyes of an observer, an image signal is provided at a frequency of 50 Hz, where in a time-multiplex process the image signal is provided at 25 Hz per eye. However, switching operations between left and right eye, and between the individual monochromatic primary colours RGB must always be carried out simultaneously. These switching operations are then preferably performed at a frequency of about 150 Hz (fine-range adjustment). In order to be able to realise all of these requirements, it is necessary that the large-range adjustment is superimposed with the fine-range adjustment. This can be done using computer-aided control and regulating algorithms.

With the help of the display device 1 or 100, it is thus possible to deform an optical element in order to influence incident light in a large adjustment range at high adjustment speed, where wave front errors and system-specific aberrations can additionally be corrected. Such a display device 1 or 100 can be used in particular in projection devices for tracking the light.

It is of course obvious that various embodiments of the display device 1 or 100 are possible, where in particular FIG. 2 only illustrates one preferred embodiment thereof, where other embodiments can be realised using various electro-dynamic, electromechanical, electromagnetic or also using magnetostrictive actuators. Modifications of the embodiments shown above are thus thinkable without leaving the scope of the invention.

Possible fields of application of the display device 1 or 100 in addition to a holographic projection device can include astronomical equipment, material treatment and machining using laser beams, or as an element of a laser resonator. It appears to those skilled in the art that the display device 1 or 100 can also be applied in other areas not mentioned above.

1. Display device for influencing incident light, with an optical element and an actuator unit for deforming the optical element, where the optical element exhibits a surface which faces the incident light, wherein the actuator unit engages sideways on the optical surface of the optical element.

2. Display device according to claim 1, wherein the actuator unit comprises at least one main actuator which can exert a force on the optical element in a direction which is perpendicular to an optical axis of the optical element.

3. (canceled)

4. Display device according to claim 2, wherein at least one auxiliary actuator is provided which can set a deflection direction of the surface of the optical element.

5. Display device according to claim 2, wherein the main actuator comprises a lever which applies the bending moment on the optical element on the one hand and which is pivotally supported relative to its environment on the other, where the main actuator is assigned with at least one auxiliary actuator on which the lever of the main actuator is supported relative to its environment, where the auxiliary actuator can perform a compensating movement to the lever movement and wherein the at least one auxiliary actuator can exert a compressive force on the optical element radial to its optical axis, in addition to the bending moment applied by the main actuator.

6. (canceled)

7. Display device according to claim 4, wherein the at least one auxiliary actuator is provided for tracking the position of the bearing of the optical element.

8. Display device according to claim 1, wherein the optical surface of the optical element can be curved with a radius of curvature which is adjustable in an adjustment range of R=(∞; 250 mm) to R=(+250 mm; +∞), according to an influence on the light.

9. Display device according to claim 8, wherein a frequency in a range of between 2 Hz and 20 Hz, preferably 5 Hz, is used for deforming the optical element in a large adjustment range.

10. (canceled)

11. Display device according to claim 4, wherein the auxiliary actuator is a piezo-actuator.

12. Display device according to claim 2, wherein the main actuator is an electro-dynamic drive, in particular a linear or rotating electromagnetic plunger coil drive.

13. (canceled)

14. Display device according to claim 1, wherein the optical element is held in a frame which is formed by the actuator unit and which comprises holding elements which are disposed on opposite sides of the optical element and into which the optical element is clamped, where the holding elements are connected to at least one main actuator each, in particular to the lever, for applying the bending moment on the optical element.

15. Display device according to claim 14, wherein the frame is designed as a compensator for an elongation of the optical element, so that the optical element is not stretched in addition to its deflection.

16. (canceled)

17. (canceled)

18. Method for influencing light which is incident on an optical element, where the light which is incident on the optical element is imaged, wherein the optical element is a part of a display device according to claim 1, wherein the optical element is deformed with the help of an actuator unit which engages sideways on the optical surface.

19. Method according to claim 18, wherein a force for deforming the optical element is applied on the optical element outside an optical surface.

20. (canceled)

21. (canceled)

22. Method according to claim 18, wherein wave front errors of a wave front which is imaged with the help of at least one deflection element, where the wave front hits the deflection element at an angle, are corrected with the help of the display device with the optical element.

23. Method according to claim 18, wherein the chromatic aberration, in particular the longitudinal chromatic aberration, is corrected with the help of the display device with the optical element.

24. (canceled)

25. Method according to claim 18, wherein the optical element is manufactured by performing the following steps:
Machining of a carrier material to predefined parameters,
Deposition of a material which serves as optical layer on to the carrier material,
Treatment of the material which serves as optical layer in a milling process, in particular with the help of a rotating diamond tool.

26. Method according to claim 18, wherein a light wave front is tracked along an optical axis of a holographic projection device for representing three-dimensional scenes by way of deforming the optical element of the display device, in particular in response to a monitoring of the eyes of at least one observer.

27. System for adjusting the position of an image plane of an image in the normal direction to the image plane with a controller and a display device according to claim 1, wherein the display device is to be adjusted in response to an output signal of a sensor.

28. System according to claim 27, wherein the sensor is a position detection sensor.

29. System according to claim 28, wherein a large-range adjustment is performed at a frequency of between 2 Hz and 20 Hz, in particular at 5 Hz, in order to move the image plane of the image to the position of an observer as detected by the position detection sensor.

30-32. (canceled)
